(19) United States
(12) Patent Application Publication
(10) Pub. No.: US 2017/0215606 A1
(43) Pub. Date: Aug. 3, 2017

(54) TWO-SIDED LENTICULAR TAG AND DISPLAY

(71) Applicants: Paul McKee, Mazomanie, WI (US); Warren Slabaugh, Rockton, IL (US)

(72) Inventors: Paul McKee, Mazomanie, WI (US); Warren Slabaugh, Rockton, IL (US)

(73) Assignee: Heartwood Creation Inc., Rockford, IL (US)

(21) Appl. No.: 15/492,721

(22) Filed: Apr. 20, 2017

Related U.S. Application Data
(62) Division of application No. 13/182,877, filed on Jul. 14, 2011, now abandoned.
(60) Provisional application No. 61/366,822, filed on Jul. 22, 2010.

(51) Int. Cl. A47F 11/06; A47F 7/00; G02B 27/06; G09F 3/02; G09F 19/12; A47F 5/02; G09F 3/18

(52) U.S. Cl. CPC A47F 11/06; A47F 5/02; A47F 7/00; G09F 3/18; G09F 3/02; G09F 19/12; G02B 27/06

(57) ABSTRACT

A lenticular tag display system and a lenticular tag are provided. The tag display system includes a display structure having an axis of rotation and a set of the lenticular tags, removably connected to the display structure. Each tag in the set of lenticular tags has a first lenticular image selected by a name program and a second lenticular image that is a souvenir image. Each tag is oriented relative to the display structure such that an axis of lenticulation of the lenticular tag is parallel to the axis of rotation of the display structure.

### CROSS-REFERENCE TO RELATED PATENT APPLICATIONS

This patent application is a Divisional of co-pending U.S. patent application Ser. No. 13/182,877, filed Jul. 14, 2011, which claims the benefit of U.S. Provisional Patent Application No. 61/366,822, filed Jul. 22, 2010, the entire teachings and disclosure of which are incorporated herein by reference thereto.

### FIELD OF THE INVENTION

This invention generally relates to souvenirs and displays of souvenirs, and more particularly to tag style souvenirs and hanging displays for tag style souvenirs.

### BACKGROUND OF THE INVENTION

It is common in the souvenir industry to personalize various types of souvenirs with first names in an effort to make them more attractive to consumers. U.S. Pat. No. 7,921,032 to Mudrick issued Apr. 5, 2011, discloses one method of how to use a name program to select a plurality of names to display on a set of solar powered souvenir tags such as keychains. However, other methods of selecting a group of names may be used. The name program disclosed in Mudrick involves selecting the most common first names from census data for a desired age range, and including those names on the souvenir set. This attempts to display the names that are most likely to be purchased in an attempt to increase the potential for profits.

Lenticular imaging is also used in the souvenir industry. Lenticular imaging is a method of combining a plurality of interlaced images underneath a plurality of lenses to create a motion sequence of images that can be viewed as the lenticular image is rotated about an axis of rotation parallel to a longitudinal axis of the lenses. Using lenticular images on souvenirs is one way to make those items more attractive to potential customers.

There exists a need in the art to provide a souvenir using lenticular images that incorporates the personalization of a name program as well as a souvenir image. There is a need in the art to display the souvenir in an advantageous way such that potential customers can easily see the motion sequence of the lenticular images.

The invention provides improvements over prior art souvenirs and souvenir display systems.

### BRIEF SUMMARY OF THE INVENTION

A new and improved lenticular souvenir tag, display system incorporating a lenticular souvenir tag and a method of displaying lenticular souvenir tags is provided. The new and improved lenticular souvenir tag has a lenticular image on a first side that is based on a name program and a lenticular image on a second side that relates to a souvenir image (i.e. a location or event specific to where the souvenir is purchased). The new and improved tag, display system and methods increase the attention grabbing aspects of the souvenir tag when displayed, among other things.

In one aspect, an embodiment of the invention provides a lenticular tag display system. A first embodiment of this aspect includes a display structure and at least one set of lenticular tags. The display structure has an axis of rotation, and further comprises a plurality of support members. The set of lenticular tags comprises a plurality of tags. Each tag is removably attached to a support member of the display structure. Each tag in the set of tags includes a first lenticular image. The first lenticular image includes at least a first and a second image. The first lenticular image has an axis of lenticulation. When the first lenticular image rotates about its axis of rotation relative to a viewer, the rotation changes which one of the first and second images the viewer viewers. Each tag is also oriented relative to the display structure such that its axis of lenticulation aligns parallel to the axis of rotation of the display structure.

In another embodiment, each tag further includes an attachment arrangement. Each attachment arrangement removably engages a support member of the display structure. In a more particular embodiment, the support member is a hook.

In another embodiment, each tag is generally self-orienting such that a hanging axis passing through a vertex of the attachment arrangement and a center of gravity of the tag is parallel to the axis of lenticulation. In a more particular embodiment, the tag self-orients such that its axis of lenticulation is parallel to the pull of gravity. In a more particular embodiment, the vertex and the center of gravity are offset from one another along the hanging axis.

In another embodiment, the first lenticular image of each tag in the first plurality of tags is determined by a name program. As such, the first lenticular image of each tag is a different name. In a more particular embodiment, each tag further comprises a second lenticular image. The second lenticular image has at least a third and a fourth image. The second lenticular image also has an axis of lenticulation that is parallel to the axis of lenticulation of the first image. In a more particular embodiment, the second lenticular image is a souvenir image. In this embodiment, the first lenticular image of the plurality of tags is a plurality of names such that each of the first lenticular images in the plurality of tags is different for each tag. The second lenticular image of the plurality of tags is a souvenir image such that the second lenticular image of the plurality of tags is substantially the same for each tag.

In another embodiment, the lenticular tag display system further comprises a motorized lenticular advertising display. The motorized lenticular advertising display shows a motion sequence of a subject without requiring any movement of the display relative to the viewer. In this manner, the display may catch a potential customer's eye.

In another embodiment, the tag is a keychain. The keychain includes a main body. The main body has a width of between approximately 0.75 inches and 1.5 inches and a length of between approximately 2 inches and 3 inches. In another embodiment, the tag is a zipper pull. The zipper pull has a main body. The main body has a width of between approximately 0.25 inches and 0.75 inches and a length of between approximately 0.5 inches and 1.25 inches.

In a further embodiment, the display system includes a second plurality of tags substantially identical to the first plurality of tags. Each tag of the second plurality of tags has a different name. As such, the display system can display more than one tag having the same name (for example, one tag from the first plurality of tags may include the name “John” and a second identical tag from the second plurality of tags will also include the name “John”). Identical tags will typically hang on the same support member.

In a further embodiment, the display system includes a third plurality of tags. Each tag of the third plurality of tags has a same first lenticular image of a same name. The third plurality of tags being substantially identical to at least one tag of the first plurality of tags and identical to at least one tag of the second plurality of tags. In this embodiment, if it is desired to have additional support members support the same name, the third plurality of tags may represent this second or third support member with the name “John.”

In another aspect, an embodiment of the invention provides a two-sided lenticular tag. A first embodiment of this aspect includes a main body, an attachment arrangement, a first lenticular image, and a second lenticular image. The main body has a first side and a second side. The attachment arrangement is rotatably attached to the main body. The first lenticular image includes at least a first image and a second image. The first lenticular image is selected by a name program, and is located on the first side of the main body. The second lenticular image includes at least a third and a fourth image. The second lenticular image is a souvenir image, and is located on the second side of the main body. Rotation of the tag about the axis of lenticulation relative to a viewer causes the viewer to see a motion sequence defined by a viewed one of the first lenticular image and the second lenticular image.

In another embodiment, the tag is a keychain. The main body has a width of between approximately 0.75 inches and 1.5 inches and a length of between approximately 2 inches and 3 inches. In another embodiment, the tag is a zipper pull. The main body has a width of between approximately 0.25 inches and 0.75 inches and a length of between approximately 0.5 inches and 1.25 inches.

In another embodiment, the attachment arrangement includes a vertex configured to contact a support member of a display structure. The vertex is offset from a center of gravity of the tag and the main body in a direction parallel to the axis of lenticulation. In a more particular embodiment, a hanging axis extends through the vertex and the center of gravity of the tag. The tag is generally self-orienting such that, when the vertex contacts the support structure, the hanging axis is oriented parallel to the pull of gravity.

In another embodiment, each of the first and second surfaces of the main body of the tag defines a recessed region, and the shape of each recessed region is substantially the same size and shape as the first and second lenticular images. In another embodiment, each of the first and second lenticular images further includes a plurality of lenticular lenses, oriented in a direction parallel to the axis of lenticulation.

In another aspect, a method of displaying a plurality of souvenir tags is provided. The method includes providing a first plurality of souvenir tags, each tag including a first lenticular image having at least a first and second image, the first lenticular image being a name, the first lenticular image having an axis of lenticulation, rotation about the axis of lenticulation causes a viewer to see a motion sequence defined by the first lenticular image, each tag including a support structure configured to hang the souvenir tag; and hanging the first plurality of souvenir tags from a support structure of a display system being rotatable about a rotational axis such that the axis of lenticulation is parallel to the rotational axis of the display system.

This arrangement allows the tags to be advantageously displayed to catch the attention of a consumer. As the consumer passes by the tags, the consumer will view the motion sequence of the lenticular tags due to his/her motion. Alternatively, if the display system rotates and the consumer is stationary, the consumer will also see the motion sequence of the lenticular image.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an exploded view of a two-sided lenticular tag according to the teachings of an embodiment of the present invention.

FIGS. 2-3 are a simplified drawings illustrating the lenticular technology used on the lenticular tag of FIG. 1;

FIGS. 4-8 are front views of a first side of the two-sided lenticular tag of FIG. 1;

FIGS. 9-13 are top views of the two-sided lenticular tags shown in FIGS. 4-8;

FIGS. 14 and 15 are perspective views of a rotating display for a plurality of sets of two-sided lenticular tags;

FIGS. 16 and 17 are top views of the rotating display of FIGS. 14 and 15;

FIG. 18A shows a perspective view of the two-sided lenticular tags arranged on a display system;

FIG. 18B shows a top view of the two-sided lenticular tags shown in FIG. 18A; and

FIG. 19 is a perspective view of an alternative embodiment of the rotating display of FIGS. 14 and 15.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

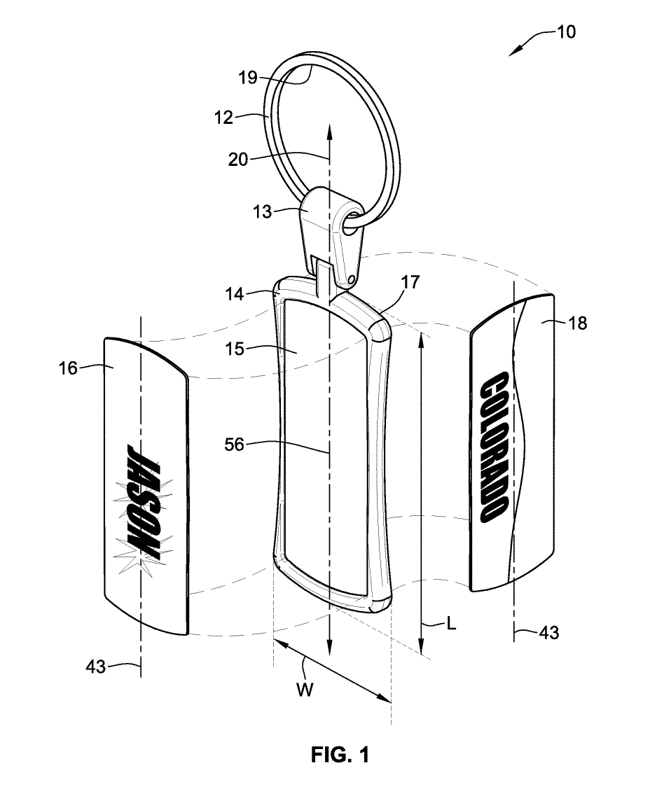

Beginning with FIG. 1, a souvenir in the form of a two sided lenticular tag 10 is illustrated. The tag 10 is generally comprised of an attachment arrangement 12, rotatably attached at a joint 13 to a main body 14, and first and second lenticular images 16, 18. The lenticular images 16, 18 preferably include one name image (see the first lenticular image 16) and one souvenir image (see the second lenticular image 18).

The attachment arrangement 12 takes the form, in this embodiment, of a circular ring which defines a concave vertex 19. The vertex 19 is a point on an inner surface of the attachment arrangement 12. The vertex 19 is offset from the main body 14 in a direction parallel to an axis of lenticulation 20, (which is discussed in more detail below). The vertex 19 is also a greater distance from the main body than any other point on the inner surface in a direction parallel to the axis of lenticulation 20. The attachment arrangement 12 is shown as a ring, wherein the ring is slidable along its circumference within the joint 13 of the tag 10, and the vertex 19 may be any point along the ring. In this embodiment, the vertex 19 is preferably substantially centered along the width W of the tag 10. In other embodiments, the attachment arrangement 12 may be a variety of shapes, such as a diamond or triangle, wherein a corner of the diamond or triangle is the vertex 19. A center of gravity 56 is also preferably centered along the width W.

The main body 14 is generally flat with a first surface 15 and a second surface 17. The first and second surfaces 15, 17 each define a recessed region and a surrounding outer peripheral portion. The first lenticular image 16 is fixed to the first surface 15 of the main body 14, and is located in the recessed region thereof The second lenticular image 18 is fixed to the second surface 17 of the main body 14, and is located in the recessed region thereof The recessed regions of the first and second surfaces 15, 17 are substantially the same shape and size as the first and second lenticular images 16, 18, which aids in the alignment of the first and second lenticular images 16, 18 relative to the main body 14. The recessed regions also help protect the edges of the first and second lenticular images 16, 18 from external forces encountered during normal use of the tag 10, which might otherwise cause the lenticular images 16, 18 to become unattached to the main body 14. The first and second lenticular images 16 and 18 may be fixed to the main body by a variety of methods, including any appropriate adhesive or mechanical fastening.

In a preferred embodiment, the lenticular tag 10 is a keychain, wherein the main body 14 has a width W at its widest cross-section of between approximately 0.75 inches and 1.5 inches and a length L at its longest cross-section of between approximately 2 inches and 3 inches. In an alternative embodiment, the tag is a zipper pull having a width W of between approximately 0.25 inches and 0.75 inches and a length L of between approximately 0.5 inches and 1.25 inches. Other embodiments are also contemplated, including a jewelry pendant.

In a preferred embodiment, the first lenticular image 16 is one of a plurality of name images selected using a name program such that a plurality of the tags 10 will have a plurality of different names. The second lenticular image 18 is a souvenir image. A “souvenir image” herein shall be an image selected to represent the location or event where the tag 10 will be sold.

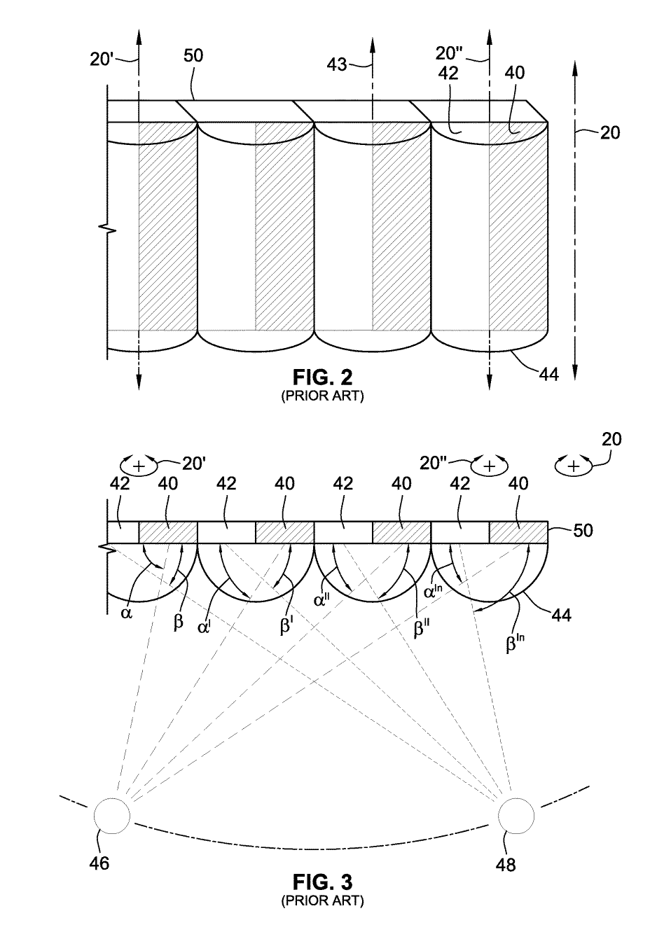

Referring next to FIGS. 2 and 3, the structure of a representative lenticular image 50 is illustrated in simplified form. A sequence of images including a first image 40 and a second image 42 are arranged in a plurality of interlaced thin strips under a plurality of lenticular lenses 44 such that exactly one strip from each image is generally beneath every lenticular lens 44, and the strips from each image are arranged such that they alternate with each other, and are therefore arranged in the same sequence beneath every lens. Each lens 44 has a longitudinal axis 43 oriented parallel to the strips of the images beneath it. The longitudinal axes 43 of the lenses 44 are arranged parallel to each other such that as the lenticular image 50 rotates relative to a viewer about any axis parallel to the longitudinal axis 43 of the lenses 44 (this axis of rotation will be referred to hereinafter as an “axis of lenticulation 20”), the image seen by the viewer alternates between the first and second images 40 and 42. As such, the lenticular image 50 may rotate relative to the viewer about any axis of lenticulation, for example, about axes 20, 20′, and 20″, and result in alternating images seen by the viewer.

Similarly, a viewer in a first viewing position 46 at a first range of viewing angles α, α′, α″, α″″ relative to the lenticular image 50 sees the first image 40, while a viewer in a second viewing position 48 at a second range of viewing angles (β, β′, β″, β″″ relative to the lenticular image 50 sees the second image 42. Thus, as the lenticular image 50 and the viewer rotate relative to each other about an axis of lenticulation 20, the image seen by the viewer changes from the first image 40 to the second image 42 and back again as the range of viewing angles changes.

Two images, namely, the first and second images 40 and 42, are used in FIGS. 2 and 3 merely to illustrate the concept of lenticular images. Typically, several different images are arranged beneath a series of lenticular lenses in the manner described such that the viewer views a series of images that convey a motion sequence. As such, more than two images may be interlaced with one another.

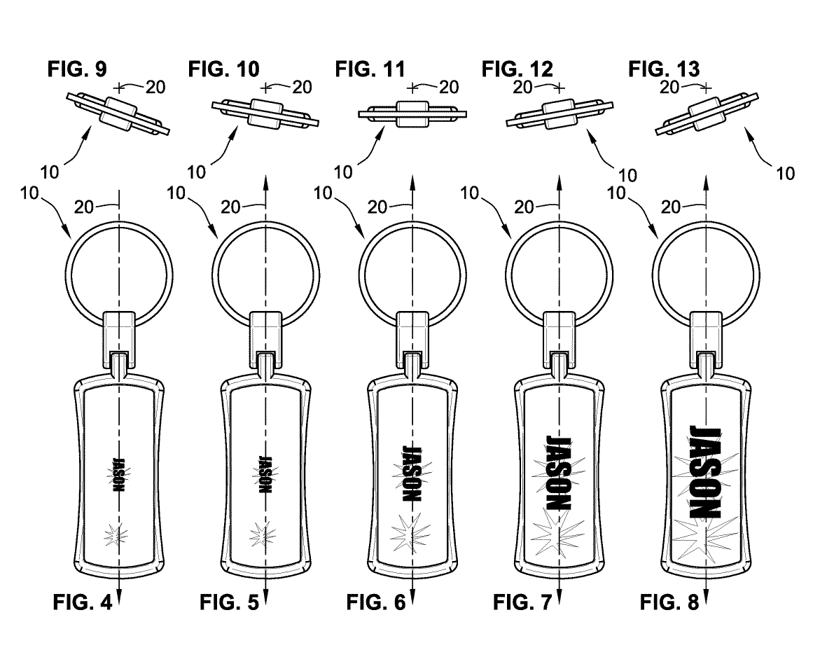

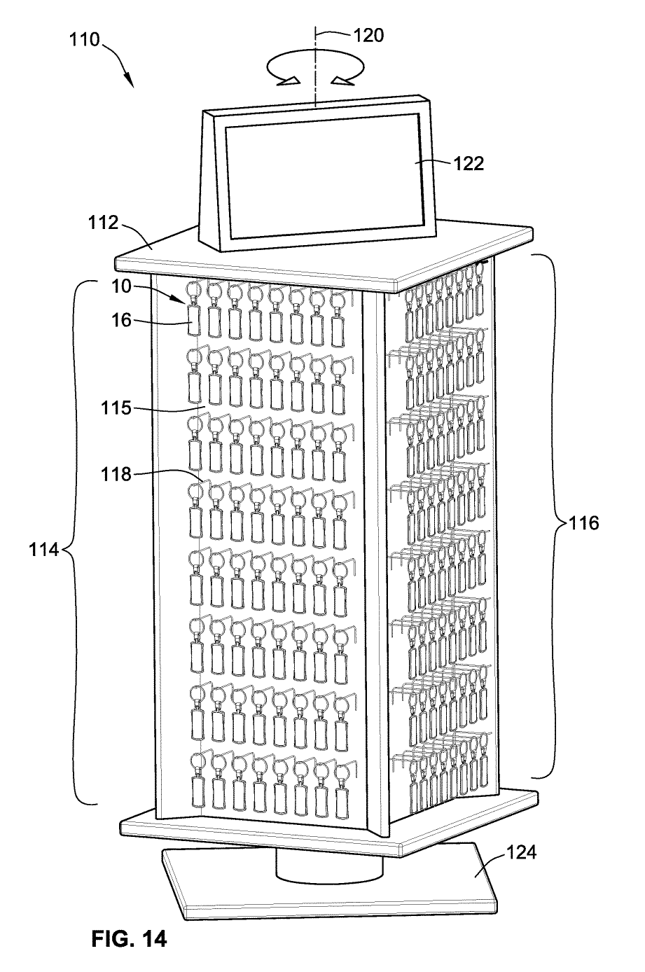

Turning now to FIGS. 4-8 and FIGS. 9-13, a simplified representation of a lenticular tag 10 rotating about an axis of lenticulation 20 is shown. The tag 10 is oriented such that the first lenticular image 16 is viewed. As the tag 10 rotates about the axis of lenticulation 20, the viewer sees a motion sequence of exploding fireworks and a name selected by the name program getting larger or smaller depending on the direction of rotation.

The motion sequence of a lenticular image may be any of a variety of different sequences. A motion sequence defined by the name program, for example, may be a name growing larger or smaller, or it may be a name changing colors. The name may also stay the same size and color, while a background sequence such as the fireworks shown in FIGS. 4-8 changes size or color. A motion sequence of a souvenir image may be a recognizable geographic location changing from day to night or an object (i.e. a dolphin or a motorcycle) moving across the tag 10. These examples are illustrations only, and all acceptable motion sequences appropriate for a name program and for a souvenir image are contemplated herein.

Turning now to FIG. 14, a lenticular tag display system 110 is shown and will be discussed in detail. The display system 110 is comprised generally of a display 112 having a plurality of display surfaces 115 separating separate display regions of the display 112 from one another. The display surfaces extend generally upward relative to a base 124 and surround a central axis 120 about which the lenticular tag display system 110 rotates.

A plurality of mounting devices illustrated in the form of peg hooks 118 are removably or permanently attached to each display surface 115 such that a first set of lenticular tags 114 may be displayed relative to a first display surface in a first display region, and a second set of lenticular tags 116 may be displayed relative to a second display surface in a second display region.

Each set of lenticular tags 114 and 116 is comprised of a plurality of lenticular tags such as the lenticular tag 10 described above having a name image and a souvenir image. The embodiment of the display system shown in FIG. 14 has four display surfaces and accommodates four sets of lenticular tags. However, alternative embodiments of the display system 110 may have one or more display surfaces having one or more display regions.

The first lenticular image 16 of the first set of lenticular tags 114 is determined by a name program, such that the plurality of first lenticular images 16 within the first set of lenticular tags 114 comprise the names selected by the name program. The tags 10 in the set of lenticular tags are arranged relative to the display structure 110 such that the first lenticular image 16 of each tag 10 faces generally outward toward the viewer and may be viewed by a potential purchaser. This allows the purchaser to easily select the specific name he or she desires. In a preferred embodiment, each unique name selected by the name program is displayed on at least one hook 118, and no hook 118 accommodates more than one name. More preferably, the names are arranged alphabetically, first from left to right across a top row of hooks 118, and then from the top to the bottom of the display system 110. Also, multiple hooks 118 may display the same name depending on the popularity of the name.

The second lenticular images 18 of the first set of lenticular tags 114 are a first lenticular souvenir image. Thus, the first set of lenticular tags 114 have a plurality of different names on the first set of lenticular images 16, and substantially identical second lenticular images 18. As such, each tag 10 of the first set of lenticular tags 114 all have one side that is substantially the same, namely, the souvenir image.

The second set of lenticular tags 116 is configured similar to the first set of lenticular tags 114 such that the name program selects a plurality of names for the first lenticular images 16 for the tags 10 in the second set of tags 116, and the second lenticular image 18 of the second set of tags 116 is a second souvenir image, different from the first souvenir image.

Different sets of tags having different name images or souvenir images may be hung on any additional display surfaces 115.

In one embodiment, a motorized lenticular advertising display 122 is fixedly attached at a top end of the display system 110. The motorized display moves a plurality of images behind a lenticular screen such that a viewer may view a motion sequence of a subject without any movement relative to the advertising display 122. This helps attract the attention of potential purchasers.

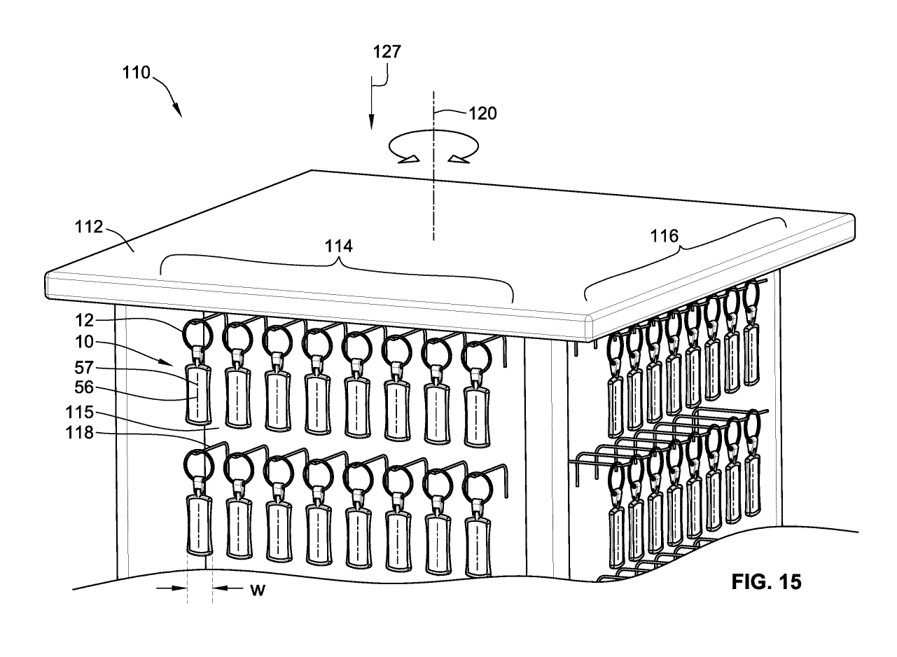

Turning now to FIG. 15, it can be seen that each tag 10 is removably mounted using its attachment arrangement 12 to a hook 118. The attachment arrangement 12 is arranged such that the vertex 19 of the attachment arrangement 12 contacts the hook 118. Because the vertex 19 and the center of gravity 56 are centered along the width W and the vertex 19 is offset from the main body in a direction parallel to the axis of lenticulation 20, a hanging axis 57 passing through the vertex 19 and the center of gravity 56 hangs parallel to the pull of gravity 127 when the vertex 19 contacts the hook 118. Further, the recessed region of each of the first and second surfaces 15, 17 (shown in FIG. 1) generally aids in the alignment of the first and second lenticular images 16, 18 respectively relative to the main body 14 such that the axes of lenticulation 20 of the first and second lenticular images 16, 18 are parallel to each other and to the hanging axis 57. This allows the axis of lenticulation 20 to also be oriented parallel to the direction of the pull of gravity 127. This also allows the tags 10 to be self-orienting such that the axis of lenticulation 20 will be parallel to the rotational axis 120 of the display system 110.

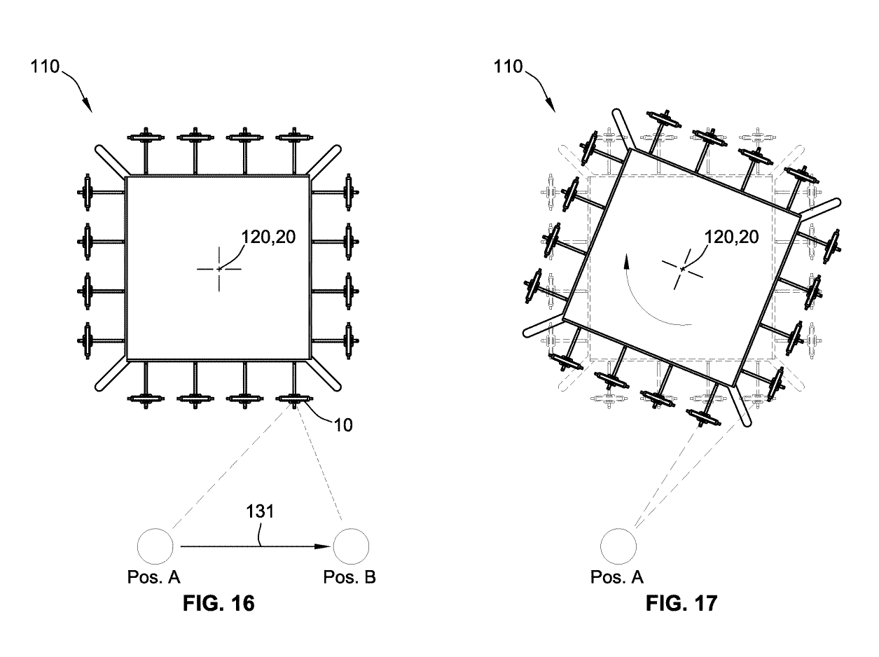

FIG. 16 shows a first way in which the display system 110 provides an advantageous arrangement for the display of the lenticular tags 10 to promote attracting the attention of a potential purchaser. A viewer who walks by the display system from Position A to Position B as illustrated by the arrow 131 will experience a change in viewing angle relative to the tags 10. In this manner, the viewer will view a first image of the first lenticular image 16 from Position A, and a second image of the first lenticular image 16 from Position B. Thus, the motion of the viewer as the viewer walks from Position A to Position B causes the tag to rotate relative to the viewer about the axis of lenticulation 20, and causes the viewer to view the motion sequence effect of the first lenticular image 16 of the tag 10. This effect is best viewed when the tag is arranged such that the axis of lenticulation 20 is arranged generally perpendicular to a travel path of the viewer.

FIG. 17 shows a second way in which the display system 110 provides an advantageous arrangement for the display of the lenticular tags 10 to promote attracting the attention of a potential purchaser. A viewer may stand in a single Position A as the display system 110 rotates about an axis 120. Because the tags are arranged such that the axis of lenticulation 20 is parallel to the axis of rotation 120, a stationary viewer will view the motion sequence provided by the first images 16 of the lenticular tags 10 in a similar manner as discussed with regard to FIG. 16. In a first embodiment, the display system 110 is not motorized such that the display system 110 rotates only upon manual manipulation. In an alternative embodiment, the display system 110 includes a motor and is motorized such that the display system 110 continuously rotates slowly about its axis 120.

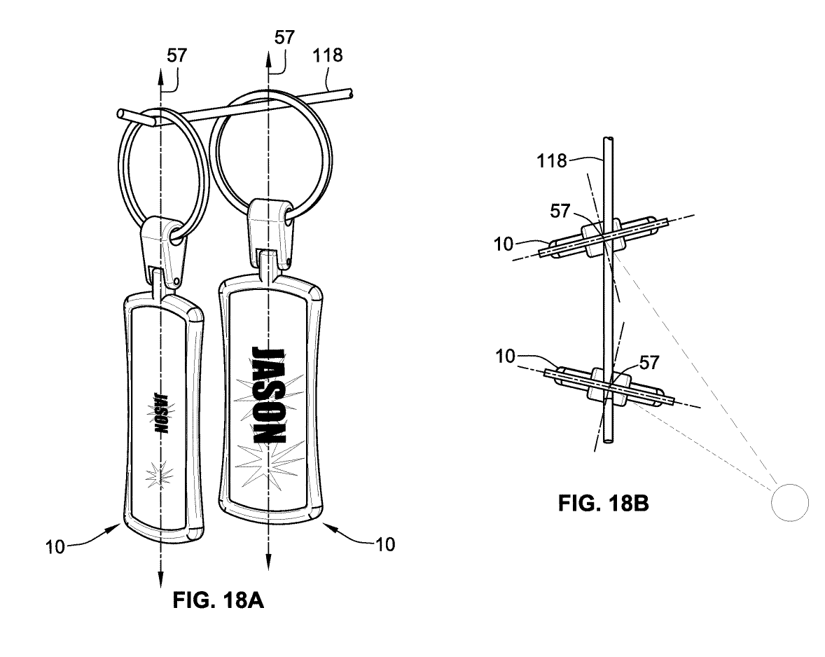

FIGS. 18A and 18B show a third way in which the display system 110 provides an advantageous arrangement of displaying lenticular tags 10. Although the tags 10 are self-orienting such that the axis of lenticulation 20 is oriented parallel to the pull of gravity, the tags 10 have some limited freedom to rotate about their hanging axes 57 when they are removably attached to the hooks 118. As such, adjacent tags 10, and consequently, the first lenticular images 16 of the adjacent tags 10, may be slightly rotated relative to each other when hung from a hook 118, as shown in FIGS. 18A and 18B. In this way, the tags 10 may be positioned such that a viewer can simultaneously view images within the first lenticular images 16 that are different from each other, as shown in FIG. 18A. For example, a viewer may see a name having a large size on a first one of the tags 10, and the same name having a smaller size on a second one of the tags 10 due to a slight rotation of each tag about its hanging axis 57. The rotation about the hanging axes 57 may occur at the time the tags 10 are hung from the hooks 118, or it may also occur due to gusts of air caused, for example, by a door opening and closing in a retail environment, by wind if the display system 110 is located outside, or by a person walking by the display system 110. As such, the slight rotation of the tags 10 relative to each other on each hook 118 may increase the visual interest of the display system 110.

This slight rotation of the tags 10 relative to hook 118 is permitted because the interface between the attachment arrangement 12 and the hook 118 is short in an axial direction and is therefore almost a point contact. This configuration provides a limited pivot point to allow the aforementioned limited variation in angular orientation of individual tags relative to a single hook 118.

Thus, the display system 110 provides various ways to catch the eye of prospective customers because the longitudinal axis 43 of the lenses, and consequently the axis of lenticulation 20, is arranged to be parallel to the axis of rotation 120 of the display system 110 and generally perpendicular to the relative travel path 131 between the viewer and the tags 10. Again, the tag 10 is designed such that the hanging axis 57 passing through the vertex 19 and the center of gravity 56 is parallel with the axis of lenticulation 20 such that the tags are self-orienting in this beneficial way. Also, the tags 10 have some degree of freedom to rotate about an axis of lenticulation while hanging from the hooks 118.

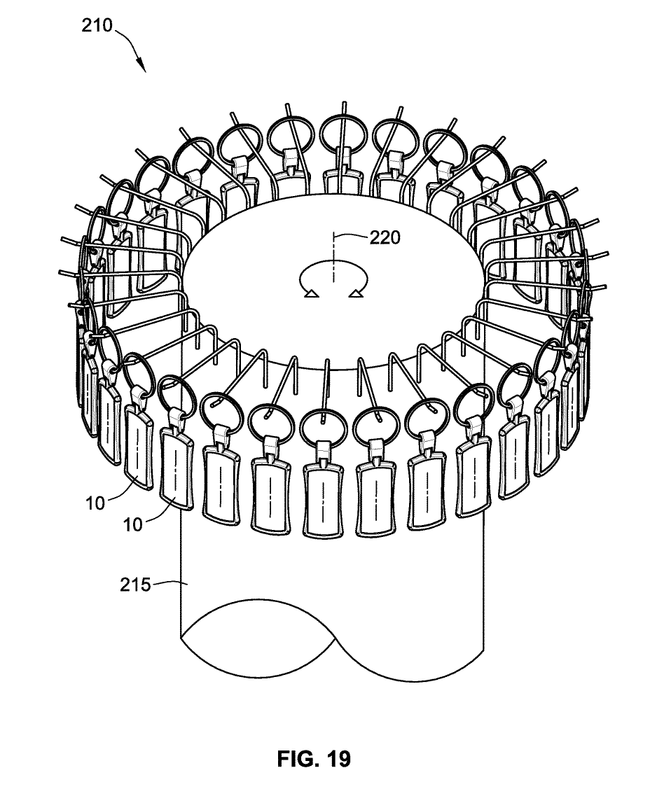

Turning now to FIG. 19, an alternative embodiment of the display system 210 is illustrated. The display system 210 has a continuous and generally circular display surface 215, and rotates about an axis of rotation 220. The tags 10 of the display system 210 are generally self-orienting in a manner similar to the tags of the display system 110, creating the same advantageous ways in to catch the eye of the customer.

The display systems 110 and 210 may be made of one or more various suitable rigid materials, including but not limited to wood, rigid plastic, and metal. The display units 110 and 210 are two of many different configurations of a lenticular tag display system wherein the axis of lenticulation is advantageously arranged relative to an axis of rotation of the display or perpendicular to a travel path of the viewer to catch the customer's eye.

In a preferred method of operation, a name program is used to select a plurality of names, and a motion sequence such as the fireworks sequence discussed above is selected. A plurality of first lenticular images 16 are created, displaying the plurality of selected names within the selected motion sequence. A second souvenir image is then selected as the second lenticular image 18. The plurality of first lenticular images 16 are placed on the first surface 15 of each tag 10 in the first plurality of tags 114, and the second lenticular image 18 is placed on the second surface 17 of each tag 10 in the first plurality of tags 114.

The first plurality of tags 114 is then hung from the hooks 118 at its attachment arrangement 12. Due to the position of the center of gravity 56 in relation to the vertex 19 and the axis of lenticulation 20, the tags self-orient such that when mounted with the vertex 19, the axis of lenticulation 20 aligns with the pull of gravity 127 and parallel to the axis of rotation 120. The plurality of tags 114 are placed on the hooks 118 such that the first lenticular image 16 having the name program image faces outward. The plurality of tags 114 is further arranged such that the tags are alphabetically organized, first from left to right, and then from the top to the bottom of the display system 110.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A two-sided lenticular tag, the tag comprising:
a main body having a first side and a second side;
an attachment arrangement rotatably attached to the main body;
a first lenticular image having at least a first and second image, the first lenticular image being located on the first side of the main body; and
a second lenticular souvenir image having at least a third and fourth image, the second lenticular image being located on the second side of the main body, wherein rotation of the tag about an axis of lenticulation relative to a viewer causes the viewer to see a motion sequence defined by a viewed one of the first lenticular image and the second lenticular image.

2. The tag of claim 1, wherein the tag is a keychain and its main body has a width of between approximately 0.75 inches and 1.5 inches and a length of between approximately 2 inches and 3 inches.

3. The tag of claim 1, wherein the tag is a zipper pull and its main body has a width of between approximately 0.25 inches and 0.75 inches and a length of between approximately 0.5 inches and 1.25 inches.

4. The tag of claim 1, wherein the attachment arrangement includes a vertex configured to contact a support member of a display structure and to allow the tag to pivot relative to the support structure, the vertex being offset from a center of gravity of the tag and the main body in a direction parallel to the axis of lenticulation.

5. The tag of claim 4, wherein a hanging axis extends through the vertex and the center of gravity of the tag, and the tag is generally self-orienting such that, when the vertex contacts the support structure, the hanging axis hangs parallel to the pull of gravity and the axis of lenticulation.

6. The tag of claim 1, wherein each of the first and second surfaces defines a recessed region, and the shape of the recessed region of the first surface is substantially the same size and shape as the first lenticular images and the shape of the recessed region of the second surface is substantially the same size and shape as the second lenticular image.

7. The tag of claim 1, wherein each of the first and second lenticular images further includes a plurality of lenticular lenses, oriented in a direction parallel to the axis of lenticulation.

8. A method of displaying a plurality of souvenir tags comprising:
providing a first plurality of souvenir tags, each tag including a first lenticular image having at least a first and second image, the first lenticular image being a name, the first lenticular image having an axis of lenticulation, rotation about the axis of lenticulation causes a viewer to see a motion sequence defined by the first lenticular image, each tag including a support structure configured to hang the souvenir tag; and
hanging the first plurality of souvenir tags from a support structure of a display system being rotatable about a rotational axis such that the axis of lenticulation is parallel to the rotational axis of the display system.
